(19) United States
(12) Patent Application Publication
(10) Pub. No.: US 2018/0069920 A1
(43) Pub. Date: Mar. 8, 2018

(54) LOAD BALANCING SYSTEM FOR SERVER TERMINAL AND METHOD

(71) Applicant: HON HAI PRECISION INDUSTRY CO., LTD., New Taipei (TW)

(72) Inventor: SHIH-MING HUANG, New Taipei (TW)

(21) Appl. No.: 15/371,318

(22) Filed: Dec. 7, 2016

(30) Foreign Application Priority Data
Sep. 6, 2016 (CN) 201610804348.5

(51) Int. Cl. H04L 29/08; H04L 29/06; H04L 29/12

(52) U.S. Cl. CPC H04L 67/1002; H04L 61/2007; H04L 67/42

(57) ABSTRACT

A load balancing system includes a client terminal and a server terminal. The client terminal is configured to communicate with the server terminal. The client terminal includes at least one client. The server terminal includes a control module and at least one server. The control module includes an assigning unit and a storing unit. The storing unit is configured to store a plurality of IP addresses, and each server corresponds to one unique IP address. The assigning unit is configured to assign an IP address to the requesting client after one client sends a request to the server terminal. The requesting client is configured to obtain the IP address and to connect to the corresponding server according to the obtained IP address. A load balancing method is also provided.

### FIELD

The subject matter herein generally relates to load balancing systems.

### BACKGROUND

A load balancer is used in a load balancing system to improve a performance of a server terminal.

### BRIEF DESCRIPTION OF THE DRAWINGS

Implementations of the present disclosure will now be described, by way of example only, with reference to the attached figures.

FIG. 1 is a block diagram of one exemplary embodiment of a load balancing system.

FIG. 2 is a block diagram of a control module of the load balancing system of FIG. 1.

FIG. 3 is a flow chat of one exemplary embodiment of a load balancing method.

FIG. 4 is a first exemplary embodiment of the load balancing system of FIG. 1.

FIG. 5 is a second exemplary embodiment of the load balancing system of FIG. 1.

FIG. 6 is a third exemplary embodiment of the load balancing system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

The present disclosure is described in relation to a load balancing system for a server terminal. The load balancing system is used to improve a performance of the terminal.

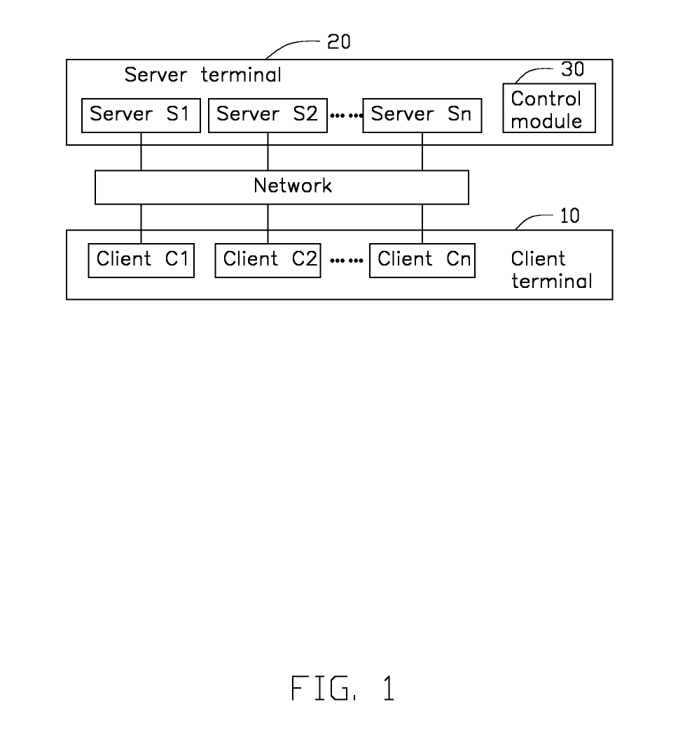

FIG. 1 illustrates an exemplary embodiment of a load balancing system. The load balancing system comprises a client terminal 10 and a server terminal 20. The client terminal 10 is configured to communicate with the server terminal 20 by network connection. The client terminal 10 comprises a plurality of clients, such as a client C1, a client C2, a client C3, . . . , and a client Cn. The server terminal 20 comprises a control module 30. The server terminal 20 further comprises a plurality of servers, namely a server S1, such as a server S2, a server S3, . . . , and a server Sn. Each server corresponds to an internet protocol (IP) address. Each IP address of the servers is stored in an IP address list. The IP address list further stores a plurality of serial numbers. Each serial number corresponds to one IP address. Each server IP address is unique. Each serial number is unique. Each client of the client terminal 10 is configured to send, by network connection, a request to the server terminal 20 for a server.

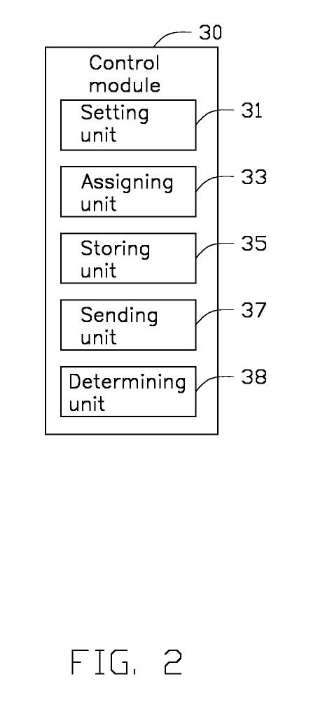

FIG. 2 illustrates that the control module 30 comprises a setting unit 31, an assigning unit 33, a storing unit 35, a sending unit 37, and a determining unit 38. When one of the clients sends a request to the server terminal 20, the requesting client is allotted a label by the setting unit 31, specifically, the first requesting client C1 is allotted 1, the second requesting client C2 is allotted 2, and the requesting client Ci is allotted i.

The assigning unit 33 is configured to assign an account, a position, and an IP address to the requesting client, according to the label of the requesting client. The account, the position, the number of the IP address, and the label of the requesting client are stored in an association list. Each client corresponds to one unique account, one unique position, and one unique IP address. Specifically, the assigning unit 33 assigns a plurality of positions P1-Px according to the number of the clients of the client terminal 10. The plurality of positions P1-Px are namely a position P1, a position P2, a position P3, . . . , and a position Px. Each client corresponds to one unique position. Each position corresponds to one server. Thus, the requesting client is configured to connect to a server according to the corresponding position. The assigning unit 33 is also configured to search the serial number of the IP address matching the label of the requesting client, according to the label of the requesting client. The assigning unit 33 is further configured to assign the IP address matching the serial number to the requesting client. For example, the IP address list stores an IP address (192.168.49.1) and a client C1. Serial number of the IP address (192.168.49.1) is 1, since the requesting client C is 1. Thus, in matching the client with an IP address, the assigning unit 33 searches for the serial number of the IP address 1 matching the number 1 in the IP address list, according to the number 1 of the client C1. The assigning unit 33 may thus find the IP address (192.168.49.1) of the serial number 1 and to assign the IP address (192.168.49.1) to the client C1.

The assigning unit 33 is further configured to obtain the number of the servers in the server terminal 20. The number of the servers is stored in the storing unit 35. The storing unit 35 is configured to store the association list and the IP address list. The association list stores a plurality of client details. Each client detail corresponds to one client. Each client detail comprises a label of a client, an account, a position, and a number of an IP address of a server. For example, in an association list {1, 2016090600001, P1, 1}, the first client detail 1 is the label of the client, the second client detail 2016090600001 is the account of the client, the third client detail P1 is the position of the client, and the fourth client detail 1 is the number of the IP address of the server.

The assigning unit 33 is further configured to obtain the IP address of the server, the position of the client, and the serial number of the IP address, according to the association list and the IP address. The sending unit 37 is configured to send the IP address of the server to the requesting client, thereby enabling the requesting client to connect to the server with the IP address. For example, the IP address list stores a serial number 1 of the IP address of the server S1 and stores the IP address 192.168.49.1 which corresponds to the serial number 1. The assigning unit 33 may thus obtains the IP address (192.168.49.1), the position P1, and the serial number 1 of the IP address (192.168.49.1), of the server S1, according to the association list {1, 2016090600001, P1, 1}. The sending unit 37 then sends the IP address (192.168.49.1) to the requesting client, thereby enabling the requesting client to connect to the server S1 corresponding to the IP address (192.168.49.1).

The determining unit 38 is configured to determine whether the number of the servers of the server terminal 20 changes. The IP address list and the association list are updated by the control module 30 when the determining unit 38 determines that the number of the servers of the server terminal 20 has changed. Specifically, the setting unit 31 sets a serial number corresponding to a new server and amends a value n of the number of the servers of the server terminal 20 when a new server is joined in the server terminal 20. For example, when a new server is joined, the setting unit 31 sets a serial number corresponding to the IP address of the new server, and the IP address and serial number of the new server are stored in the IP address list and the association list. When one of the servers is deleted from the server terminal 20, the IP address corresponding to the deleted server is deleted from the IP address list, and the serial number corresponding to the deleted server is deleted from the IP address list. The storing unit 35 is further configured to store the updated IP address list and the amended value n in relation to the number of the servers.

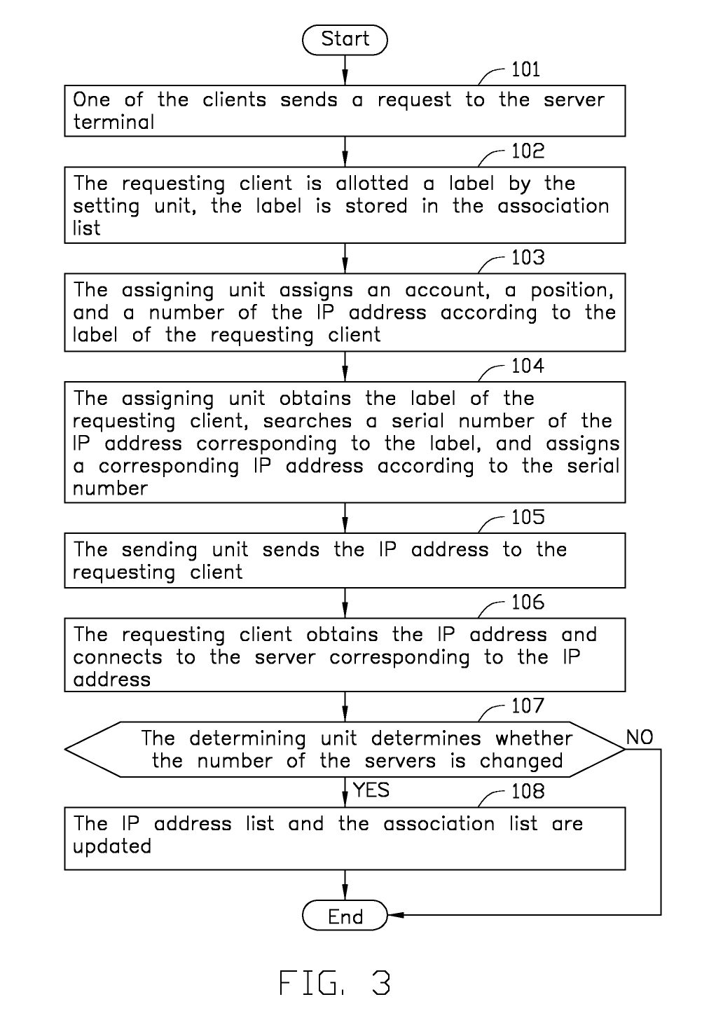

FIG. 3 illustrates a flowchart of a method in accordance with an example embodiment. A load balancing method is provided by way of example, as there are a variety of ways to carry out the method. The load balancing method described below can be carried out using the configurations illustrated in FIGS. 1-2, for example, and various elements of these figures are referenced in explaining operating system installation method.

The illustrated order of blocks is by example only and the order of the blocks can change. Additional blocks may be added or fewer blocks may be utilized without departing from this disclosure. The load balancing method can begin at block 101.

At block 101, one of the clients of the client terminal 10 sends a request to the server terminal 20.

At block 102, the requesting client is allotted a label by the setting unit 31, such as, the second requesting client C2 is allotted 2, the requesting client Ci is allotted i. The label is stored in the association list.

At block 103, the assigning unit 33 assigns an account, a position, and a number of the IP address according to the label of the requesting client.

At block 104, the assigning unit 33 obtains the label of the requesting client, searches a serial number of the IP address corresponding to the label, and assigns a corresponding IP address, according to the serial number.

At block 105, the sending unit 37 sends the IP address to the requesting client.

At block 106, the requesting client obtains the IP address and connects to the server corresponding to the IP address.

At block 107, the determining unit 38 determines whether the number of the servers of the server terminal 20 is changed. If yes, the method goes to block 108; if no, the method goes to ending.

At block 108, the IP address list and the association list are updated. Specifically, a value n of the number of the servers is amended, the updated association list and the amended value n are stored in the storing unit 35.

In one exemplary embodiment, at block 108, when a new server is joined, the setting unit 31 sets a serial number corresponding to the new server, and the serial number corresponding to the new server is added in the IP address list. If one server deleted from the server terminal 20, the IP address correspond to the deleted server is deleted from the IP address list, and the serial number correspond to the deleted server is deleted from the IP address list.

In the exemplary embodiment, each client can connect to one corresponding server, thus, the performance of the server terminal 20 can be improved.

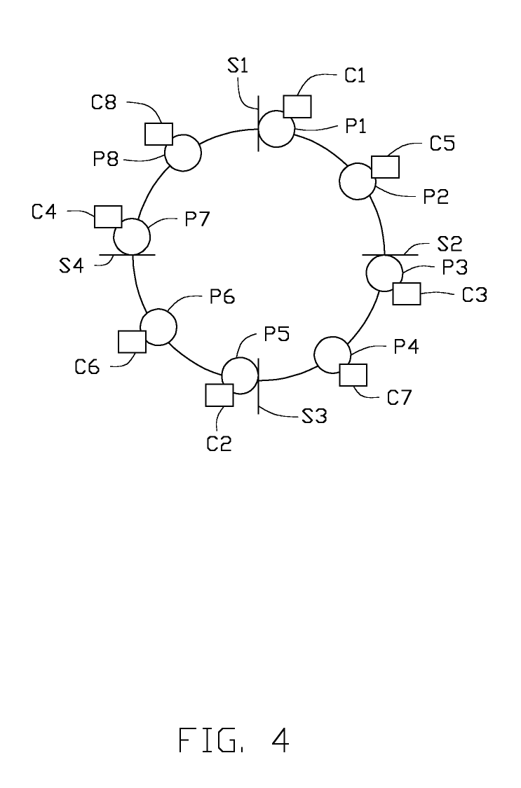

FIG. 4 illustrates that, in a first exemplary embodiment, the server terminal 20 comprises four servers, namely from S1 to S4. The client terminal 10 comprises eight clients, namely from C1 to C8. There are eight positions, namely from P1 to P8. The position P1 and the position P2 can connect to the server S1. The position P3 and the position P4can connect to the server S2. The position P5 and the position P6 can connect to the server S3. The position P7 and the position P8 can connect to the server S4. The client C1 is located at the position P1. The client C2 is located at the position P5. The client C3 is located at the position P3. The client C4 is located at the position P7. The client C5 is located at the position P2. The client C6 is located at the position P6. The client C7 is located at the position P4. The client C8 is located at the position P8. The client C1 and the client C5 can connect to the server S1. The client C3 and client C7 can connect to the server S2. The client C2 and the client C6 can connect to the server S3. The client C4 and the client C8 can connect to the server S4.

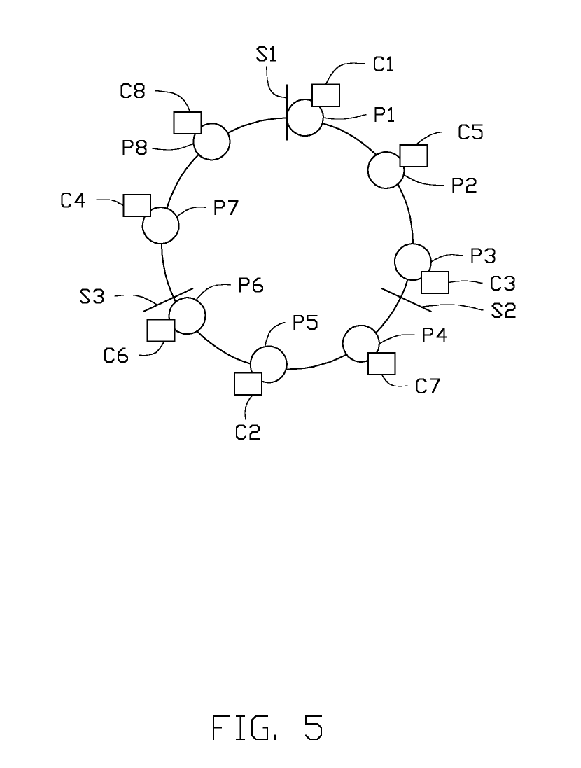

FIG. 5 illustrates that in a second exemplary embodiment, the server terminal 20 comprises three servers, namely from Si to S3. The client terminal 10 comprises eight clients, namely from C1 to C8. There are eight positions, namely from P1 to P8. The position P1, the position P2, and the position P8 can connect to the server S1. The position P3 and the position P4 can connect to the server S2. The position P5, the position P6, and the position P7 can connect to the server S3. The client C1 is located at the position P1.

The client C2 is located at the position P5. The client C3 is located at the position P3. The client C4 is located at the position P7. The client C5 is located at the position P2. The client C6 is located at the position P6. The client C7 is located at the position P4. The client C8 is located at the position P8. The client C1, the client C5, and the client C8 can connect to the server S1. The client C3 and the client C7 can connect to the server S2. The client C2, the client C4, and the client C6 can connect to the server S3.

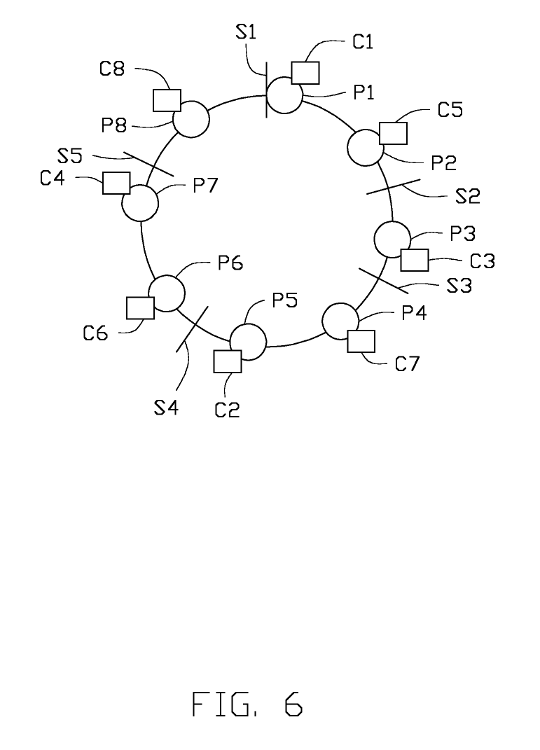

FIG. 6 illustrates that in a third exemplary embodiment, the server terminal 20 comprises five servers, namely from S1 to S5. The client terminal 10 comprises eight clients, namely from C1 to C8. There are eight positions, namely from P1 to P8. The position P1 and the position P2 can connect to the server S1. The position P3 can connect to the server S2. The position P4 and the position P5 can connect to the server S3. The position P6 and the position P7 can connect to the server S4. The position P8 can connect to the server S5. The client C1 is located at the position P1. The client C2 is located at the position P5. The client C3 is located at the position P3. The client C4 is located at the position P7. The client C5 is located at the position P2. The client C6 is located at the position P6. The client C7 is located at the position P4. The client C8 is located at the position P8. The client C1 and the client C5 can connect to the server S1. The client C3 can connect to the server S2. The client C2 and the client C7 can connect to the server S3. The client C4 and the client C6 can connect to the server S4. The client C8 can connect to the server S5.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. A load balancing system comprising:
a client terminal, the client terminal comprising at least one client; and
a server terminal comprising:
at least one server; and
a control module comprising:
an assigning unit; and
a storing unit configured to store a plurality of internet protocol (IP) addresses;
wherein each server corresponds to one unique IP address;
wherein the at least one client is configured to send a request to the server terminal;
wherein the assigning unit is configured to assign one of the IP addresses to the requesting client after one of the at least one client sends the request to the server terminal;
wherein the requesting client is configured to:
obtain the IP address; and
connect to the corresponding server according to the obtained IP address.

2. The load balancing system of claim 1, wherein the control module further comprises a setting unit, when the requesting client of the client module sends the request to the server module, the requesting client is allotted a label by the setting unit.

3. The load balancing system of claim 2, wherein when the requesting client is allotted the label by the setting unit, the assigning unit searches a serial number of the IP address matching the label of the requesting client.

4. The load balancing system of claim 3, wherein when searching a serial number of the IP address, the assigning unit assigned an IP address corresponding to the serial number.

5. The load balancing system of claim 4, wherein the assigning unit is further configured to assign a position to the requesting client after the requesting client is labeled by the setting unit, wherein the position corresponds to the IP address.

6. The load balancing system of claim 1, wherein the assigning unit is further configured to obtain the number of the servers of the server terminal.

7. The load balancing system of claim 6, wherein the control module further comprises a determining unit, the determining unit is further configured to determine whether the number of the servers of the server terminal is changed.

8. The load balancing system of claim 7, wherein the IP address is stored in an IP address list, the IP address list is stored in the storing unit, and the IP address list is updated after the determining unit determines the number of the servers of the server terminal is changed.

9. A load balancing system comprising:
at least one client; and
a server terminal configured to communicate with the server terminal, and comprising:
at least one server; and
a control module comprising an assigning unit;
wherein each server corresponds to one unique IP address;
wherein the at least one client is configured to send a request to the server terminal;
wherein the assigning unit is configured to assign one address to the requesting client after one of the at least one client sends the request to the server terminal;
wherein the requesting client is configured to:
obtain the IP address; and
connect to the corresponding server according to the obtained IP address.

10. The load balancing system of claim 9, wherein the control module further comprises a setting unit, when the client of the client module sends the request to server module, the requesting client is allotted a label by the setting unit, wherein the assigning unit is configured to assign the IP address to the requesting client according to the label.

11. The load balancing system of claim 10, wherein when one of the at least one client sends the request to the server terminal, the assigning unit is assigned a number to the requesting client according to the label.

12. The load balancing system of claim 11, wherein the number and the IP address are stored in an association list.

13. The load balancing system of claim 12, wherein the control module further comprises a determining unit, the determining unit is further configured to determine whether the number of the servers of the server terminal is changed, and the association list is updated after the determining unit determines the quantity of the servers of the server terminal is changed.

14. The load balancing system of claim 12, wherein the assigning unit is further configured to assign a position to the requesting client according to the label after one of the at least one client sends the request to the server terminal, the position is stored in the association list.

15. A load balancing method comprising:
sending a request to a server terminal by one of clients of a client terminal;
assigning an IP address of the requesting client by an assigning unit;
obtaining the IP address by the requesting client; and
connecting to the server corresponding to the IP address by the requesting client.

16. The load balancing method of claim 15, further comprising a step of labeling the requesting client a label by the setting unit after the step of sending the request to the server terminal by one of clients of a client terminal.

17. The load balancing method of claim 16, further comprising a step of searching a serial number of the IP address matching the label of the requesting client after the step of labeling the requesting client the label by the setting unit.

18. The load balancing method of claim 17, further comprising a step of assigning a corresponding IP address according to the serial number after the step of searching the serial number of the IP address matching the label of the requesting client.

19. The load balancing method of claim 15, further comprising a step of determining whether the number of the servers of the server terminal is changed by a determining unit after the step of labeling the requesting client the label by the setting unit.

20. The load balancing method of claim 19, further comprising a step of amending the value of the number of the servers after the step of determining the number of the servers of the server terminal is changed.
